(19) United States
(12) Patent Application Publication
(10) Pub. No.: US 2026/0097439 A1
(43) Pub. Date: Apr. 9, 2026

(54) HOLE SAW CONNECTING MECHANISM

(71) Applicant: Keqing HUANG, ZHEJIANG PROVINCE (CN)

(72) Inventor: Keqing HUANG, ZHEJIANG PROVINCE (CN)

(21) Appl. No.: 19/060,813

(22) Filed: Feb. 24, 2025

(30) Foreign Application Priority Data
Oct. 9, 2024 (CN) 2024224239066

(51) Int. Cl. B23B 51/04

(52) U.S. Cl. CPC B23B 51/0473

(57) ABSTRACT

A hole saw connecting mechanism, including a rotary shaft assembly and a hole-opening assembly; the rotary shaft assembly has a drill bit limiting sleeve and a limiting mechanism; the hole-opening assembly has a quick connecting head, a pilot drill bit, and a cylindrical hole saw; the limiting mechanism has a limiting steel ball and a sliding sleeve. A first limiting hole penetrates through the drill bit limiting sleeve; the limiting steel ball is in the first limiting hole; the quick connecting head has a first positioning groove to limit the limiting steel ball. The sliding sleeve has circular sidewalls of different diameters to cooperate with the limiting steel ball to achieve locked and unlocked states of the quick connecting head with respect to the drill bit limiting sleeve. The pilot drill bit is mounted to the quick connecting head or the drill bit limiting sleeve through a collar assembly.

### BACKGROUND OF THE INVENTION

The present invention relates to the field of hole saw technology, and in particular, to a hole saw connecting mechanism.

Hole saw is used as a circular saw for drilling circular holes, and is widely used for drilling holes in various materials such as metal, wood, plastics, and glass. A hole saw mainly consists of a rotary shaft and a hole saw body, which are typically connected in a threaded manner.

In practical use, traditional threaded connection has many problems when the hole saw body needs to be replaced. Specifically, after the hole saw body is used for drilling holes for repeated number of times, the threaded portion between the hole saw body and the rotary shaft is susceptible to wearing, deformation, and contamination by impurities such as scraps or dust generated during drilling. Accordingly, these often lead to issues such as thread stripping or seizing. As a result, it requires significant time and labor to remove the hole saw body, making it extremely difficult to replace the hole saw body and seriously affecting the working efficiency.

In addition, when wastes aggregate inside the hole saw body, the wastes are difficult to be removed quickly due to the tightness and structural characteristics of threaded connection. The wastes not only affect the precision and quality of subsequent hole drilling, but also adversely affect the overall performance and service life of the hole saw. For example, residual metal wastes in the hole saw may collide and scrape against the material on which a hole is to be drilled during rotation of the hole saw, resulting in surface damage to the material or irregular shape of the subsequently drilled hole; residual plastic or wood wastes may corrode the hole saw due to factors like moisture and mildew, thereby reducing the mechanical strength and reliability of the hole saw.

In summary, the existing threaded connection between the hole saw rotary shaft and the hole saw body shows obvious shortcomings in replacing the hole saw body and cleaning the wastes. Therefore, there is an urgent need for a novel hole saw connecting mechanism to solve these problems to improve the convenience of use and working efficiency of the hole saw and prolonging the service life of the hole saw.

### BRIEF SUMMARY OF THE INVENTION

It is an object of the present invention to provide a hole saw connecting mechanism, which allows for easy disassembly of a quick connecting head and a cylindrical hole saw altogether, as well as quick locking and unlocking of a pilot drill bit, thereby achieving the purpose of quick waste removal or quick replacement of the cylindrical hole saw.

The present invention is achieved through the following technical solutions:

A hole saw connecting mechanism, comprising a rotary shaft assembly and a hole-opening assembly; an upper end of the rotary shaft assembly is detachably connected to the hole-opening assembly, and a lower end of the rotary shaft assembly is configured to be connected to a driving assembly that drives the hole-opening assembly to rotate; wherein the rotary shaft assembly comprises a drill bit limiting sleeve and a limiting mechanism; the hole-opening assembly comprises a quick connecting head, a pilot drill bit, and a cylindrical hole saw; the limiting mechanism comprises a limiting steel ball, a sliding sleeve, and an upper cover; an upper end of the drill bit limiting sleeve is provided with a first accommodating cavity in which a lower end of the quick connecting head is mounted; an ejection mechanism is also provided in the first accommodating cavity; threads at an upper end of the quick connecting head are connected to the cylindrical hole saw; an inner circular sidewall of the sliding sleeve is divided into an upper inner circular sidewall and a lower inner circular sidewall; a diameter of the upper inner circular sidewall is larger than a diameter of the lower inner circular sidewall; a first limiting hole is provided penetrating through opposite sidewalls of the drill bit limiting sleeve at the upper end of the drill bit limiting sleeve corresponding to the first accommodating cavity, and the limiting steel ball is mounted in the first limiting hole; the quick connecting head is provided with a first positioning groove, and the limiting steel ball is limited within the first positioning groove; the upper cover is fixedly connected with the drill bit limiting sleeve; when the sliding sleeve is pulled downward away from the cylindrical hole saw along an axial direction of the drill bit limiting sleeve, the lower inner circular sidewall is driven to move below the limiting steel ball such that the upper inner circular sidewall is positioned corresponding to the limiting steel ball, and thus the upper inner circular sidewall no longer limits the limiting steel ball due to a larger diameter thereof compared to that of the lower inner circular sidewall, and so the limiting steel ball is allowed to move out from the first positioning groove and thus achieve an unlocked state of the quick connecting head, and the quick connecting head is allowed to be ejected by the ejection mechanism; when the sliding sleeve is reset to an original normal position through a reset assembly, the lower inner circular sidewall is driven upward such that the limiting steel ball is again abutted by the lower inner circular sidewall of the sliding sleeve, and so the limiting steel ball is being pushed back into the first positioning groove and thus achieve a locked state of the quick connecting head; the limiting steel ball moving in and out of the first positioning groove due to movements of the sliding sleeve along the axial direction of the drill bit limiting sleeve achieves said locked state and said unlocked state of the quick connecting head, such that the quick connecting head is capable to be locked or unlocked with respect to the drill bit limiting sleeve; the pilot drill bit is mounted on the quick connecting head or on the drill bit limiting sleeve through a collar assembly.

According to a further embodiment of the present invention, the pilot drill bit is mounted on the quick connecting head through the collar assembly; the collar assembly comprises a steel ball collar and a mounting steel ball; a mounting groove is formed at a lower end of the quick connecting head; a first mounting through-hole is formed on a bottom wall of the mounting groove; the steel ball collar is an open-ended collar; a second mounting through-hole is formed on a sidewall of the steel ball collar corresponding to the first mounting through-hole; a second positioning groove is formed at a lower end of the pilot drill bit; after the steel ball collar is clamped onto the mounting groove of the quick connecting head, the mounting steel ball sequentially passes through the second mounting through-hole and the first mounting through-hole and is then mounted in the second positioning groove.

According to a further embodiment of the present invention, the pilot drill bit is mounted on the drill bit limiting sleeve through the collar assembly; the collar assembly comprises a steel ball collar, a mounting steel ball, and a steel ball collar fixing sleeve; a mounting groove is formed at a lower end of the drill bit limiting sleeve; a first mounting through-hole is formed on a bottom wall of the mounting groove; the steel ball collar is an open-ended collar; a second mounting through-hole is formed on a sidewall of the steel ball collar corresponding to the first mounting through-hole; a second positioning groove is formed at a lower end of the pilot drill bit; after the steel ball collar is clamped onto the mounting groove of the drill bit limiting sleeve, the mounting steel ball sequentially passes through the second mounting through-hole and the first mounting through-hole, and at least part of the mounting steel ball is mounted in the second positioning groove of the pilot drill bit; a first limiting part and a second limiting part are provided on an inner sidewall of the steel ball collar fixing sleeve; an inner diameter of the first limiting part is smaller than an inner diameter of the second limiting part; the steel ball collar fixing sleeve is movably sleeved on the drill bit limiting sleeve movable along the axial direction of the drill bit limiting sleeve; by moving the steel ball collar fixing sleeve axially along the drill bit limiting sleeve, the first limiting part and the second limiting part are selectively positioned corresponding to the mounting steel ball to achieve a locked state and an unlocked state of the pilot drill bit respectively, thereby locking and unlocking the pilot drill bit with respective to the drill bit limiting sleeve.

According to a further embodiment of the present invention, the pilot drill bit is mounted on the drill bit limiting sleeve through the collar assembly; the collar assembly comprises a steel ball collar, a mounting steel ball, and a steel ball collar fixing sleeve; a mounting groove is formed at a lower end of the drill bit limiting sleeve a first mounting through-hole is formed on a bottom wall of the mounting groove; the steel ball collar is an open-ended collar; a second mounting through-hole is formed on a sidewall of the steel ball collar corresponding to the first mounting through-hole; a second positioning groove is formed at a lower end of the pilot drill bit; after the steel ball collar is clamped onto the mounting groove of the drill bit limiting sleeve, the mounting steel ball sequentially passes through the second mounting through-hole and the first mounting through-hole, and at least part of the mounting steel ball is mounted in the second positioning groove of the pilot drill bit; a locking protruding part and an unlocking indenting part are oppositely provided on an inner sidewall of the steel ball collar fixing sleeve; the steel ball collar fixing sleeve rotatably sleeves the drill bit limiting sleeve; the steel ball collar fixing sleeve is rotatable about the drill bit limiting sleeve, such that when the steel ball collar fixing sleeve is rotated, the mounting steel ball is abutted by the locking protruding part when the steel ball collar fixing sleeve is rotated to a position where the locking protruding part is facing to the mounting steel ball, and the mounting steel ball is allowed to move out from the second positioning groove of the pilot drill bit towards a recessed space created by the unlocking indenting part when the steel ball collar fixing sleeve is rotated to a position where the unlocking indenting part is facing to the mounting steel ball, thereby forming a locked state and an unlocked state of the pilot drill bit with respect to the drill bit limiting sleeve.

According to a further embodiment of the present invention, the collar assembly further comprises a first snap ring and a second snap ring; the drill bit limiting sleeve is provided with a first ring groove and a second ring groove; the first snap ring is fitted in the first ring groove; the second snap ring is fitted in the second ring groove; a limiting ring is provided inside an upper end of the steel ball collar fixing sleeve; the limiting ring is driven to move along the axial direction of the drill bit limiting sleeve as the steel ball collar fixing sleeve moves along the axial direction of the drill bit limiting sleeve, such that the limiting ring engages selectively with the first snap ring or the second snap ring as the steel ball collar fixing sleeve moves to different positions.

According to a further embodiment of the present invention, a projected portion and anti-skidding stripes are provided on an outer sidewall of the steel ball collar fixing sleeve; a positioning through-hole in which a rotation positioning member is mounted is formed at an upper end of the projected portion.

According to a further embodiment of the present invention, the rotation positioning member comprises a positioning pin, a positioning steel ball, and a positioning spring; the positioning pin is mounted in the positioning through-hole; one end of the positioning spring abuts against one end of the positioning pin, and another end of the positioning spring abuts against the positioning steel ball; the positioning steel ball is provided at an opening of another end of the positioning pin; a positioning recess is formed on an outer sidewall of the drill bit limiting sleeve aligning to the first mounting through-hole; when the steel ball collar fixing sleeve is rotated through the projected portion, the positioning steel ball enters into the positioning recess when the steel ball collar fixing sleeve is rotated to a position where the positioning steel ball is positioned facing to the positioning recess, and the positioning steel ball leaves the positioning recess when the steel ball collar fixing sleeve is rotated to any position where the positioning steel ball is not facing to the positioning recess.

According to a further embodiment of the present invention, the steel ball collar is provided with a locking protrusion; a U-shaped groove is formed on the quick connecting head or the drill bit limiting sleeve; the locking protrusion is inserted into the U-shaped groove.

According to a further embodiment of the present invention, the reset assembly comprises positioning pin shafts and reset springs; the positioning pin shafts sequentially pass through the drill bit limiting sleeve and the upper cover; knurled patterns at a lower end of each of the positioning pin shafts is riveted with the sliding sleeve; each of the reset springs sleeves a corresponding one of the positioning pin shafts; when the sliding sleeve is pulled downward along the axial direction of the drill bit limiting sleeve, the reset springs are in a compressed state.

According to a further embodiment of the present invention, the ejection mechanism comprises an ejection block, an ejection spring, and a spring fixing ring; the ejection spring is mounted in the first accommodating cavity through the spring fixing ring; one end of the ejection block abuts against the ejection spring, and another end of the ejection block abuts against the quick connecting head.

In summary, the present invention has the following beneficial effects:

The hole saw connecting mechanism of the present invention makes improvements in quick replacement of a hole saw, thereby facilitating more convenient and effort-saving replacement of the hole saw by a user, and improving working efficiency. According to the present invention, the quick connecting head and the cylindrical hole saw are threaded as a whole, and the quick connecting head, the drill bit limiting sleeve, and the sliding sleeve are cooperatively connected. After hole-opening operation is completed, the sliding sleeve can be pulled downward along the axial direction of the drill bit limiting sleeve, so that the lower inner circular sidewall is driven to move below the limiting steel ball such that the upper inner circular sidewall is positioned corresponding to the limiting steel ball and thus no longer limits the limiting steel ball due to its larger diameter, and so the limiting steel ball is allowed to move out from the first positioning groove and thus achieve an unlocked state of the quick connecting head; and then, the quick connecting head is allowed to be ejected by the ejection mechanism; when the sliding sleeve is reset to an original normal position through a reset assembly, the lower inner circular sidewall is driven upward such that the limiting steel ball is again abutted by the lower inner circular sidewall of the sliding sleeve, and so the limiting steel ball is being pushed back into the first positioning groove and thus achieve a locked state of the quick connecting head. The limiting steel ball moving in and out of the first positioning groove due to movements of the sliding sleeve along the axial direction of the drill bit limiting sleeve can achieve said locked state and said unlocked state of the quick connecting head, such that the quick connecting head can be locked or unlocked with respect to the drill bit limiting sleeve; accordingly, the quick connecting head and the cylindrical hole saw can be easily pulled out altogether, thereby achieving the purpose of quick waste removal or quick replacement of the cylindrical hole saw. In the present invention, the quick locking and unlocking of the pilot drill bit are achieved through the cooperative arrangements of the steel ball collar fixing sleeve, the steel ball collar, and the mounting steel ball, and this is more convenient and efficient than locking the pilot drill bit with a set screw according to conventional methods. The present invention has the advantages of convenient use, good user's experience, novel structure, low manufacturing cost, and good economic benefit, making it suitable for wide range of applications.

### BRIEF DESCRIPTION OF THE DRAWINGS

FIG. 1 is a schematic view of an overall structure of a hole saw connecting mechanism according to Embodiment 1 of the present invention;

FIG. 2 is a schematic structural top view of the hole saw connecting mechanism according to Embodiment 1 of the present invention;

FIG. 3 is a cross-sectional view of B-B in FIG. 2;

FIG. 4 is a schematic exploded structural view of the hole saw connecting mechanism according to Embodiment 1 of the present invention;

FIG. 5 is a schematic perspective view of a drill bit limiting sleeve according to Embodiment 1 of the present invention;

FIG. 6 is a schematic perspective view of a pilot drill bit according to Embodiment 1 of the present invention;

FIG. 7 is a schematic perspective view of a sliding sleeve according to Embodiment 1 of the present invention;

FIG. 8 is a schematic perspective view of an upper cover according to Embodiment 1 of the present invention;

FIG. 9 is a schematic perspective view of a cylindrical hole saw according to Embodiment 1 of the present invention;

FIG. 10 is a schematic view of an assembled structure of a quick connecting head and a steel ball collar according to Embodiment 1 of the present invention;

FIG. 11 is a schematic perspective view of the quick connecting head according to Embodiment 1 of the present invention;

FIG. 12 is a schematic perspective view of the steel ball collar according to Embodiment 1 of the present invention;

FIG. 13 is a schematic view of an overall structure of a hole saw connecting mechanism according to Embodiment 2 of the present invention;

FIG. 14 is a schematic structural top view of the hole saw connecting mechanism according to Embodiment 2 of the present invention;

FIG. 15 is a cross-sectional view of C-C in FIG. 14;

FIG. 16 is a schematic exploded structural view of the hole saw connecting mechanism according to Embodiment 2 of the present invention;

FIG. 17 is a schematic perspective view of a drill bit limiting sleeve according to Embodiment 2 of the present invention;

FIG. 18 is a schematic view of an assembled structure of a pilot drill bit and a steel ball collar fixing sleeve assembled to a drill bit limiting sleeve according to Embodiment 2 of the present invention;

FIG. 19 is a schematic perspective view of the steel ball collar fixing sleeve according to Embodiment 2 of the present invention;

FIG. 20 is a schematic view of an assembled structure of the steel ball collar, a first snap ring, and a second snap ring, assembled to the drill bit limiting sleeve according to Embodiment 2 of the present invention;

FIG. 21 is a schematic perspective view of the pilot drill bit according to Embodiment 2 of the present invention;

FIG. 22 is a schematic perspective view of a quick connecting head according to Embodiment 2 of the present invention;

FIG. 23 is a schematic view of an overall structure of a hole saw connecting mechanism according to Embodiment 3 of the present invention;

FIG. 24 is a schematic view of an assembled structure of a pilot drill bit and a steel ball collar fixing sleeve assembled to a drill bit limiting sleeve according to Embodiment 3 of the present invention;

FIG. 25 is a schematic exploded structural view of the collar assembly and the drill bit limiting sleeve according to Embodiment 3 of the present invention;

FIG. 26 is a schematic view of an assembled structure of the steel ball collar fixing sleeve and a rotation positioning member according to Embodiment 3 of the present invention;

FIG. 27 is a first schematic perspective view of the steel ball collar fixing sleeve according to Embodiment 3 of the present invention;

FIG. 28 is a second schematic perspective view of the steel ball collar fixing sleeve according to Embodiment 3 of the present invention; and

FIG. 29 is a schematic exploded structural view of a positioning assembly according to Embodiment 3 of the present invention.

In the drawings: 1—rotary shaft assembly; 2—hole-opening assembly; 3—ejection mechanism; 4—reset assembly; 5—collar assembly; 7—screw; 8—rotation positioning member; 11—drill bit limiting sleeve; 12—limiting mechanism; 21—quick connecting head; 22—cylindrical hole saw; 23—pilot drill bit; 31—ejection block; 32—ejection spring; 33—spring fixing ring; 41—positioning pin shaft; 42—reset spring; 51—steel ball collar; 52—mounting steel ball; 53—steel ball collar fixing sleeve; 54—first snap ring; 55—second snap ring; 81—positioning pin; 82—positioning steel ball; 83—positioning spring; 111—first accommodating cavity; 112—first limiting hole; 113—first ring groove; 114—second ring groove; 115—positioning recess; 121—limiting steel ball; 122—sliding sleeve; 123—upper cover; 211—first positioning groove; 212—mounting groove; 213—first mounting through-hole; 214—U-shaped groove; 221—scrap discharge groove; 231—second positioning groove; 511—second mounting through-hole; 512—locking protrusion; 531—first limiting part; 532—second limiting part; 533—limiting ring; 534—locking protruding part; 535—unlocking indenting part; 536—projected portion; 537—anti-skidding stripe; 538—positioning through-hole; 1111—positioning plane; 1223—upper inner circular sidewall; and 1224—lower inner circular sidewall.

### DETAILED DESCRIPTION OF THE INVENTION

The present invention will be described in detail below with reference to the accompanying drawings and specific embodiments. The exemplary embodiments of the present invention and the description thereof are provided herein to illustrate the present invention and are not intended to limit the present invention.

It should be noted that all directional indicators (such as upper, lower, left, right, front, rear, upper end, lower end, top, and bottom) in the embodiments of the present invention are only used to explain the relative positional relationships and movements of the components in a specific orientation (as shown in the drawings), and if the specific orientation changes, the directional indicator changes accordingly.

In the present invention, unless otherwise explicitly specified and limited, the term “connect” should be interpreted in a broad sense. For example, it may be a fixed connection, a detachable connection, or an integral connection; may be a mechanical connection or an electrical connection; may be a direct connection, an indirect connection through an intermediate, an internal communication between two elements, or an interaction between two elements, unless otherwise specified. For those of ordinary skill in the art, the specific meanings of the above terms in the present invention can be construed according to the contexts.

In addition, descriptions involving “first”, “second”, and the like, in the present invention are used for descriptive purpose only and are not to be construed as indicating or implying relative importance or implicitly indicating the number of technical features indicated. Thus, a feature defined with “first” or “second” may explicitly or implicitly implied that there is at least one of said feature. In addition, the technical solutions of different embodiments may be combined, given that they can be implemented by those of ordinary skill in the art; when a combined technical solution in which the different technical solutions contained therein are contradictory to one another in a way that the combination cannot be implemented, such combination should be considered nonexistent and should not fall within the protection scope of the present invention.

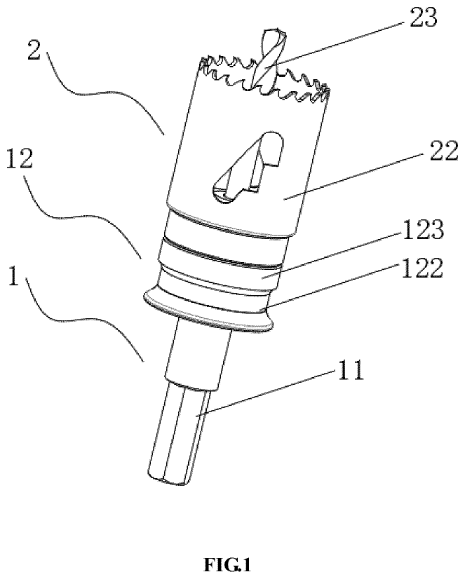

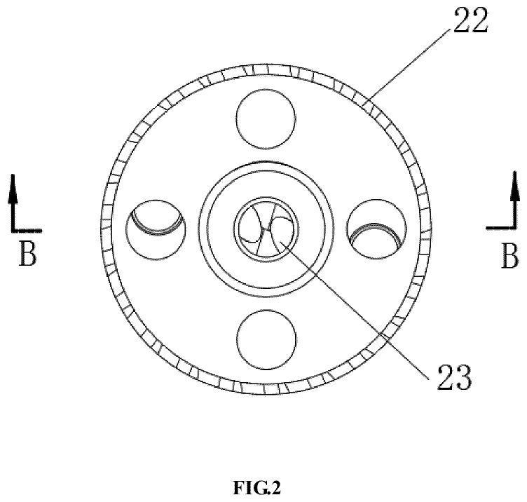

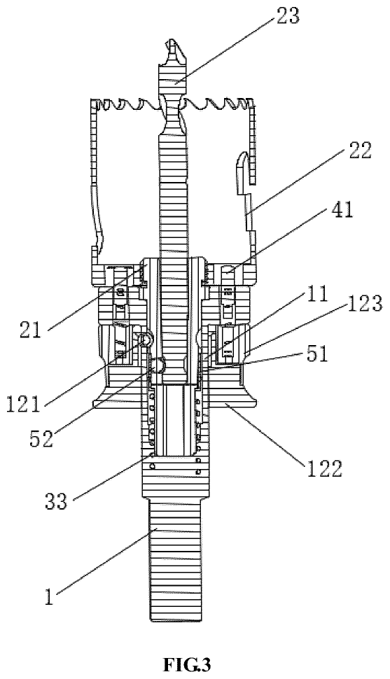

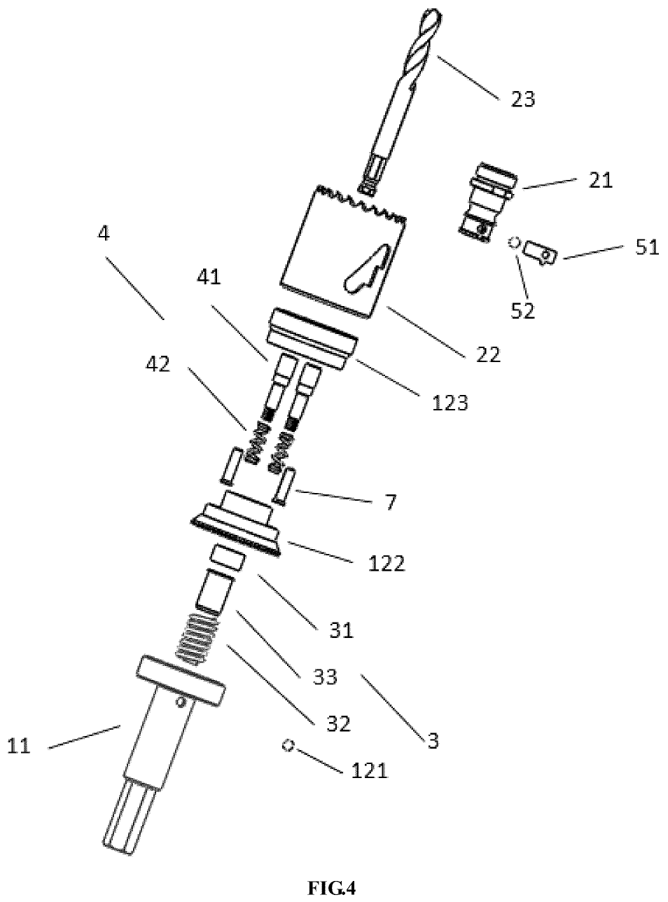

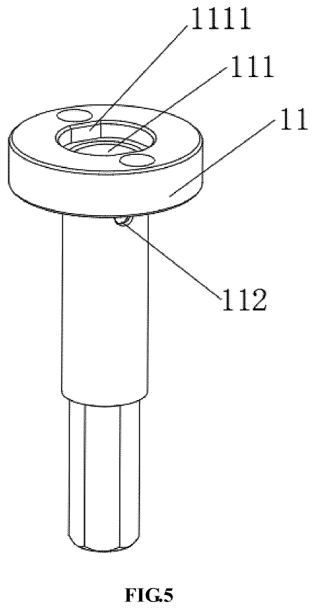

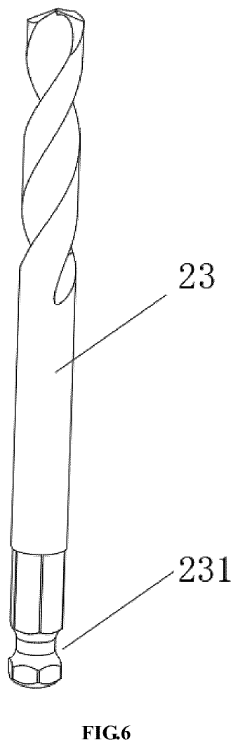

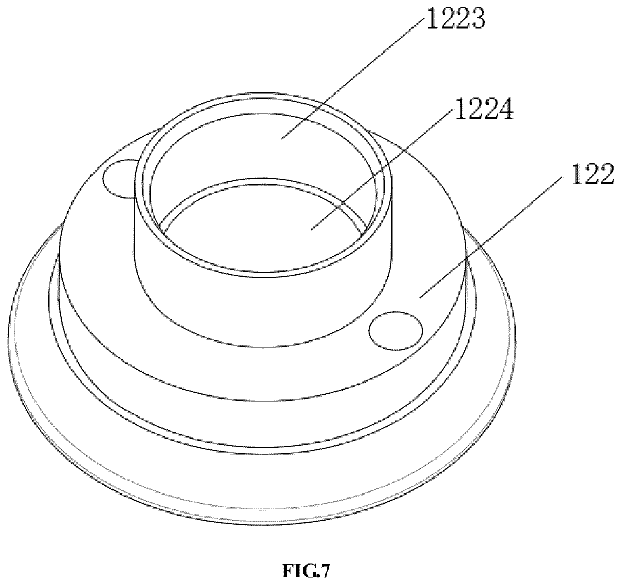

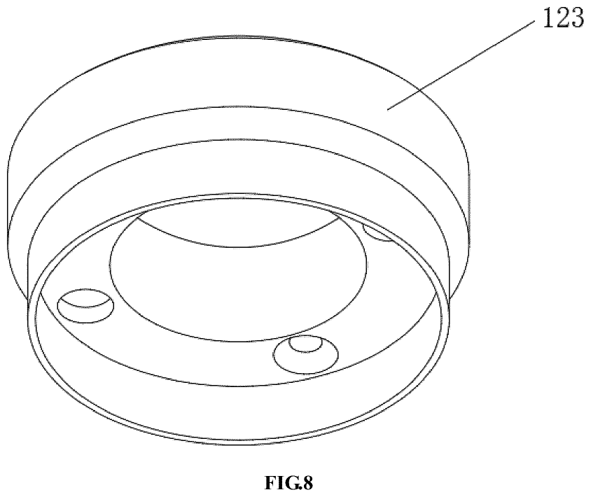

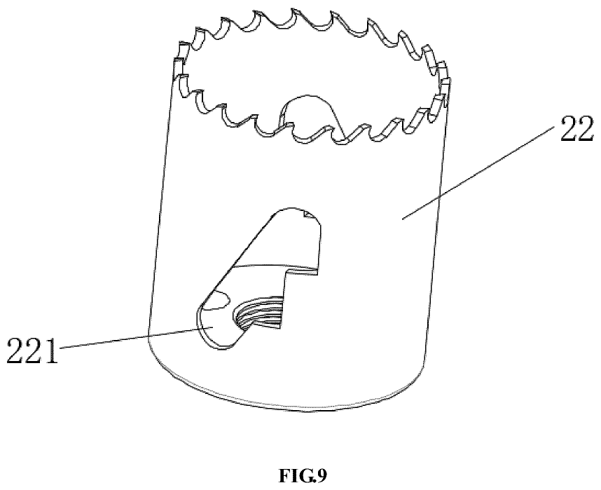

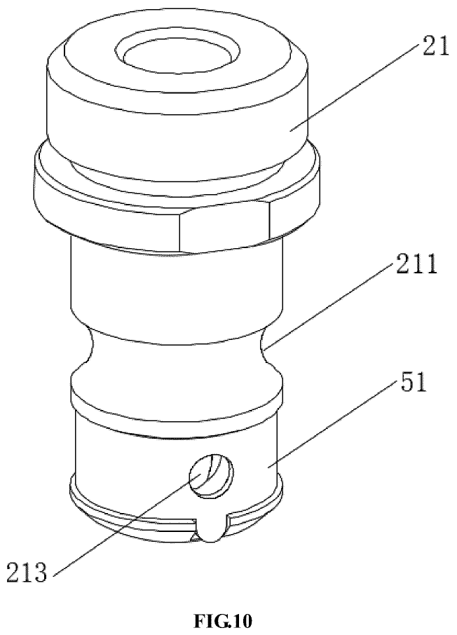

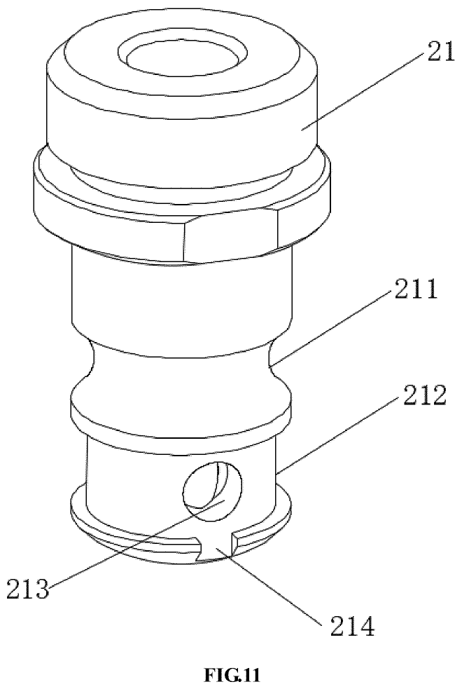

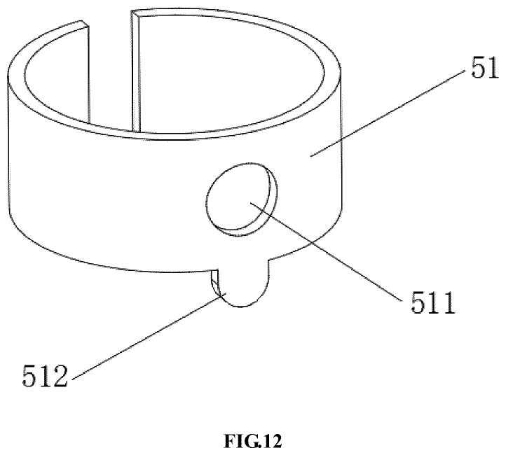

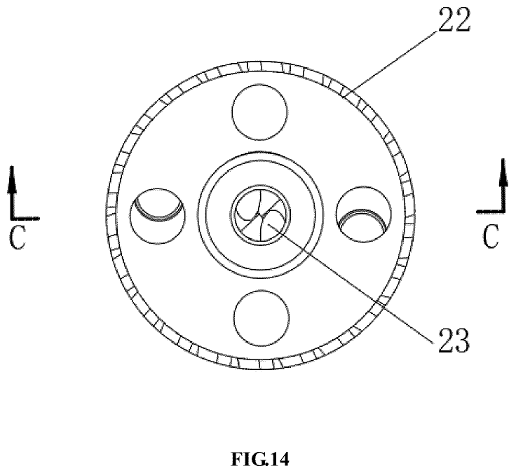

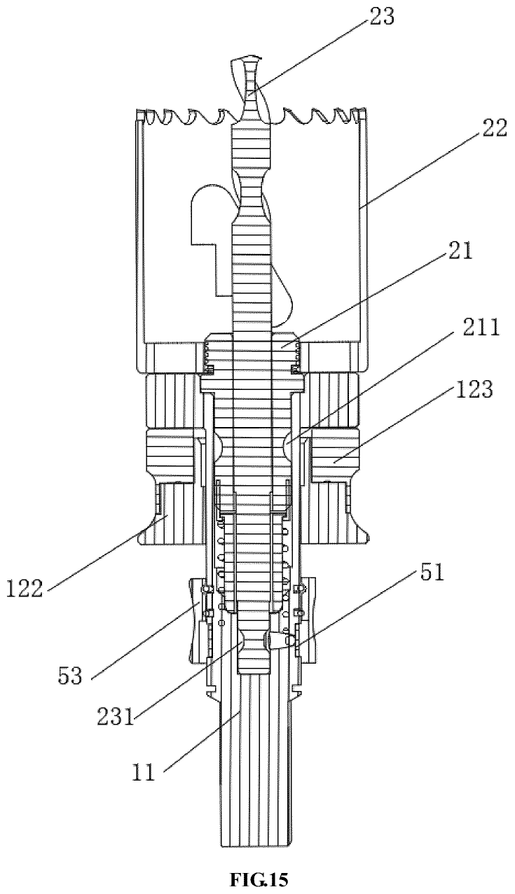

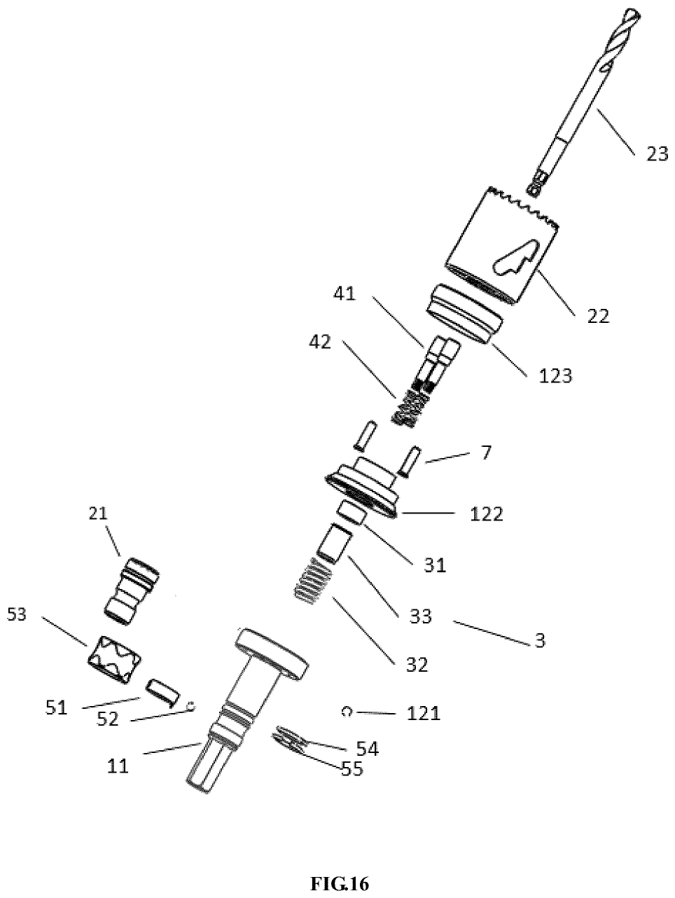

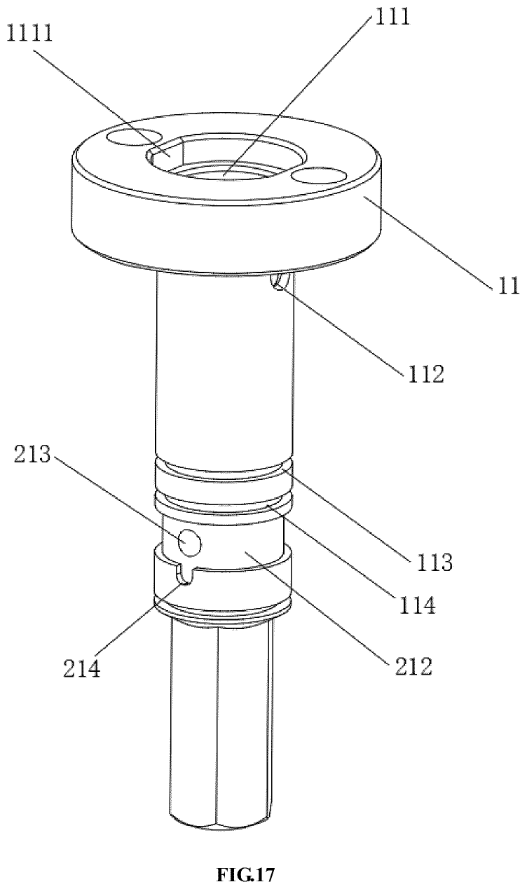

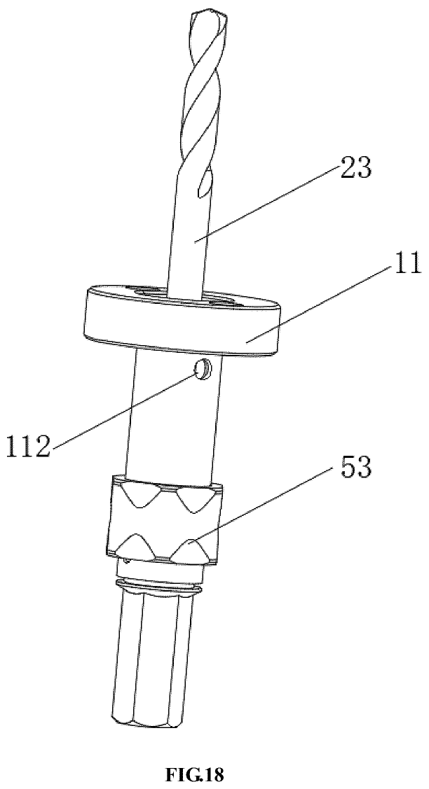

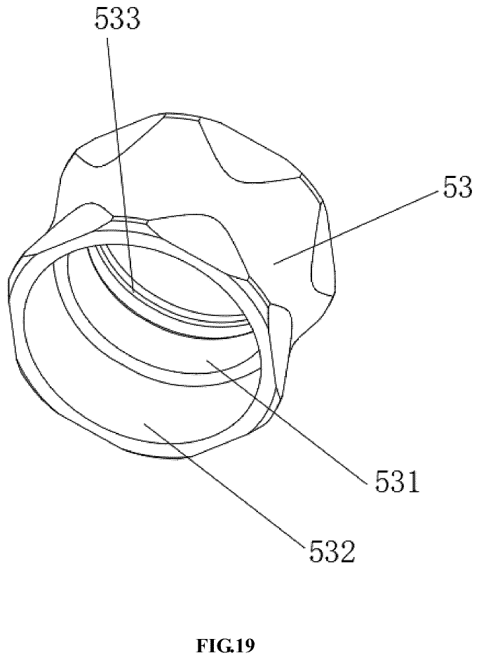

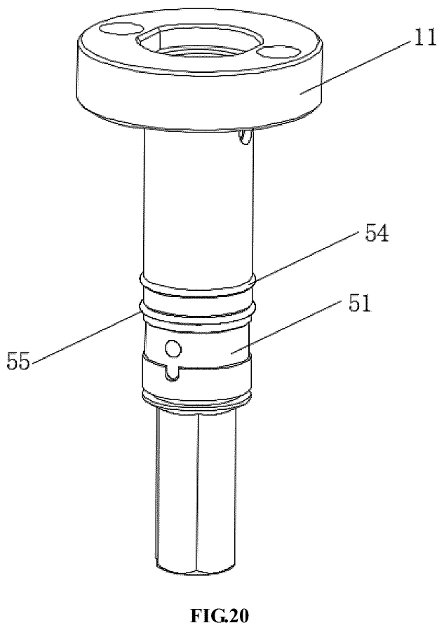

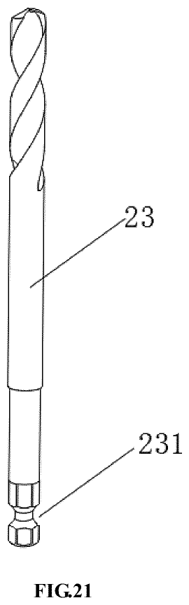

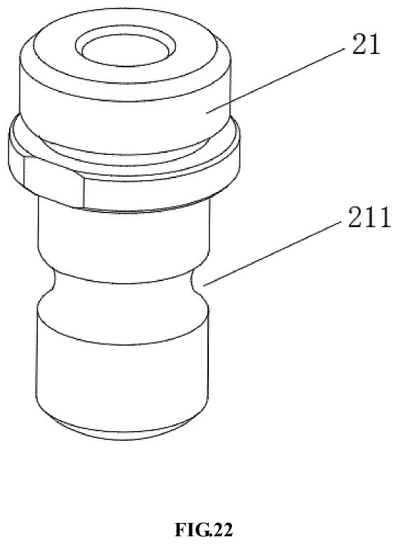

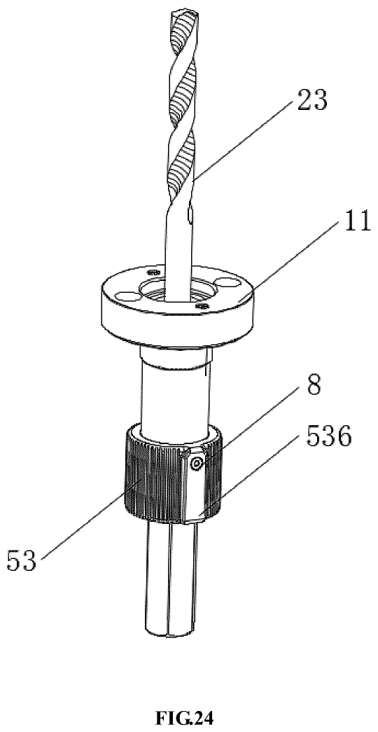

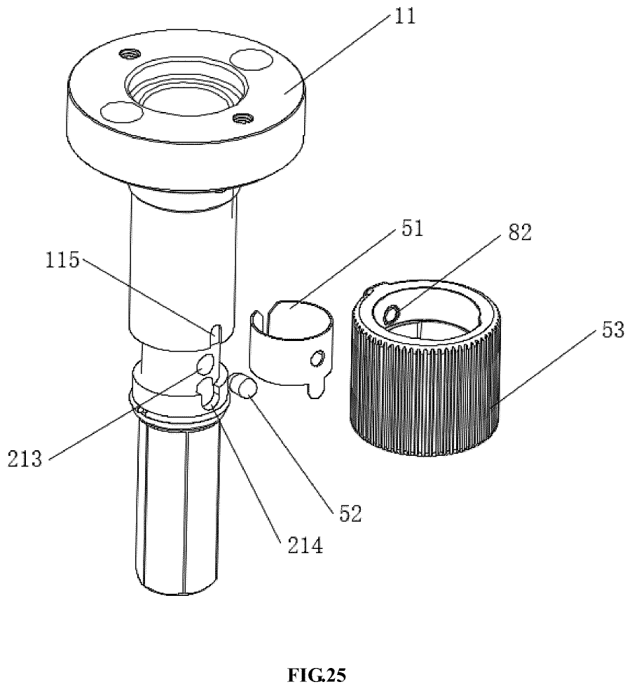

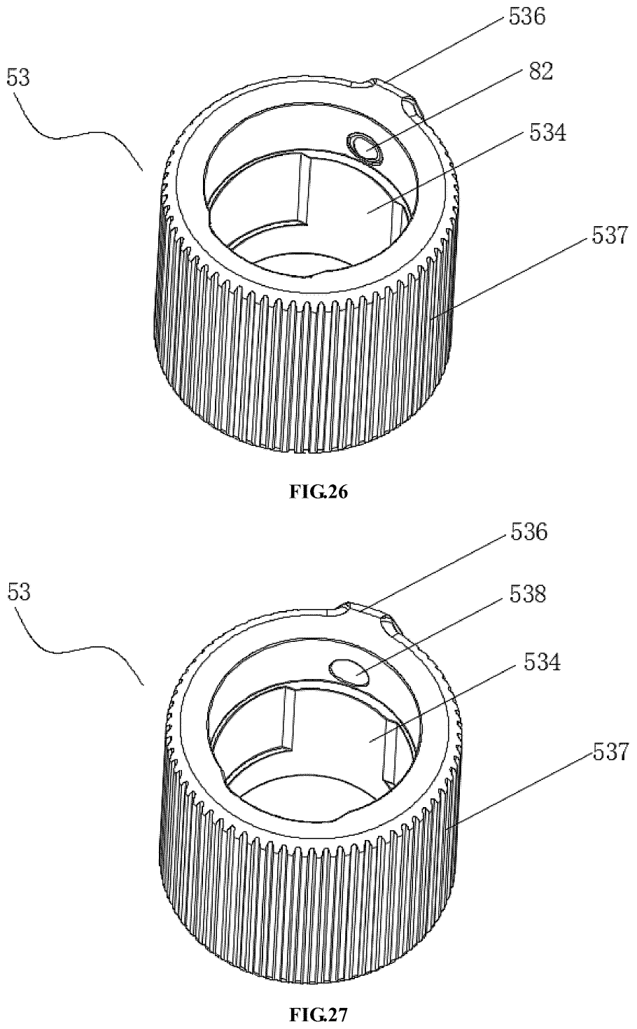

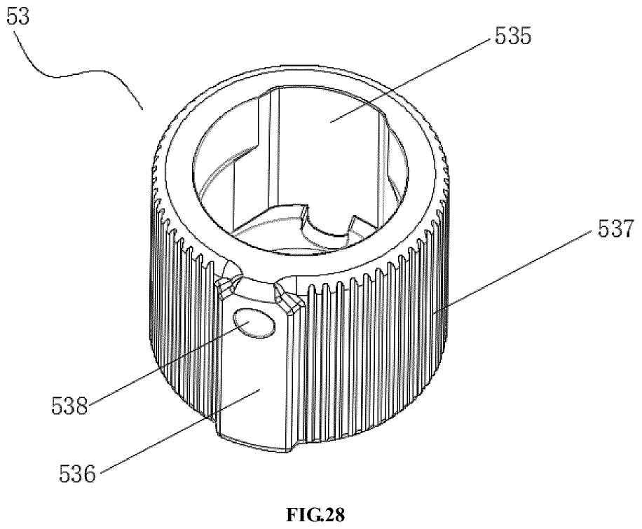

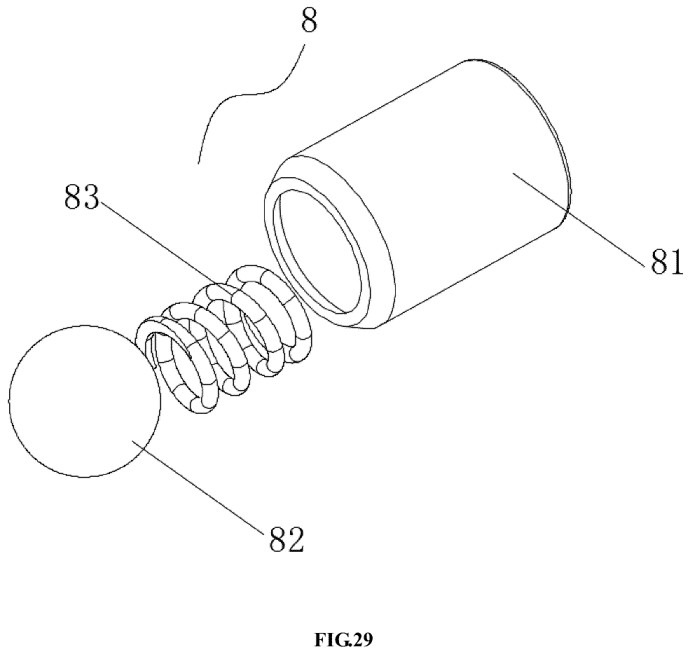

The present invention will be further described in detail below with reference to FIGS. 1-29.
Embodiment 1: As shown in FIGS. 1 to 12, a hole saw connecting mechanism comprises a rotary shaft assembly 1 and a hole-opening assembly 2; an upper end of the rotary shaft assembly 1 is detachably connected to the hole-opening assembly 2, and a lower end of the rotary shaft assembly 1 is configured to be connected to a driving assembly that drives the hole-opening assembly 2 to rotate; the rotary shaft assembly 1 comprises a drill bit limiting sleeve 11 and a limiting mechanism 12; the hole-opening assembly 2 comprises a quick connecting head 21, a pilot drill bit 23, and a cylindrical hole saw 22; the limiting mechanism 12 comprises a limiting steel ball 121, a sliding sleeve 122, and an upper cover 123; an upper end of the drill bit limiting sleeve 11 is provided with a first accommodating cavity 111 in which a lower end of the quick connecting head 21 is mounted; an ejection mechanism 3 is also provided in the first accommodating cavity 111; threads at an upper end of the quick connecting head 21 are connected to the cylindrical hole saw 22; an inner circular sidewall of the sliding sleeve 122 is divided into an upper inner circular sidewall 1223 and a lower inner circular sidewall 1224; a diameter of the upper inner circular sidewall 1223 is larger than a diameter of the lower inner circular sidewall 1224; a first limiting hole 112 is provided penetrating through opposite sidewalls of the drill bit limiting sleeve 11 at the upper end of the drill bit limiting sleeve 11 corresponding to the first accommodating cavity 111, and the limiting steel ball 121 is mounted in the first limiting hole 112; the quick connecting head 21 is provided with a first positioning groove 211, and the limiting steel ball 121 is limited within the first positioning groove 211; the upper cover 123 is fixedly connected with the drill bit limiting sleeve 11. When the sliding sleeve 122 is pulled downward (which is a direction away from the cylindrical hole saw 22) along an axial direction of the drill bit limiting sleeve 11, the lower inner circular sidewall 1224 is driven to move below the limiting steel ball 121 and the upper inner circular sidewall 1223 is now positioned corresponding to the limiting steel ball 121; since the upper inner circular sidewall 1223 has a larger diameter than that of the lower inner circular sidewall 1224, additional room created by the larger diameter of the upper inner circular sidewall 1223 allows the limiting steel ball 121 to move out from the first positioning groove 211 and thus achieve an unlocked state of the quick connecting head 21; and then, the quick connecting head 21 will be ejected by the ejection mechanism 3; when the sliding sleeve 122 is reset to an original normal position through a reset assembly 4, the lower inner circular sidewall 1224 is driven upward again such that the limiting steel ball 121 is again abutted by the lower inner circular sidewall 1224 of the sliding sleeve 122, and so the limiting steel ball 121 is being pushed back into the first positioning groove 211 and thus achieve a locked state of the quick connecting head 21. The limiting steel ball 121 moving in and out of the first positioning groove 211 due to movements of the sliding sleeve 122 along the axial direction of the drill bit limiting sleeve 11 can achieve said locked state and said unlocked state of the quick connecting head 21, such that the quick connecting head 21 can be locked or unlocked with respect to the drill bit limiting sleeve 11; the pilot drill bit 23 is mounted on the quick connecting head 21 or on the drill bit limiting sleeve 11 through a collar assembly 5. As described and explained above, the lower inner circular sidewall 1224 is driven to move below the limiting steel ball 121 such that the upper inner circular sidewall 1223 is positioned corresponding to the limiting steel ball 121 and thus no longer limit the limiting steel ball 121 due to its larger diameter when the sliding sleeve 122 is pulled downwardly, and so the limiting steel ball 121 is allowed to move out from the first positioning groove 211 and thus achieve an unlocked state of the quick connecting head 21 which will then be ejected by the ejection mechanism 3; accordingly, removal and replacement of the cylindrical hole saw 22 is facilitated, thereby achieving the purpose of quick removal of wastes or quick replacement of the cylindrical hole saw 22; when the sliding sleeve 122 is reset to the original normal position, the lower inner circular sidewall 1224 abuts against the limiting steel ball 121, and so the limiting steel ball 121 is being pushed back into the first positioning groove 211, such that the drill bit limiting sleeve 11 and the quick connecting head 21 are locked again, and thus the mounting of the cylindrical hole saw 22 is completed.

Specifically, in this embodiment, the pilot drill bit 23 is mounted on the quick connecting head 21 through the collar assembly 5; the collar assembly 5 comprises a steel ball collar 51 and a mounting steel ball 52; a mounting groove 212 is formed at a lower end of the quick connecting head 21; a first mounting through-hole 213 is formed on a bottom wall of the mounting groove 212; the steel ball collar 51 is an open-ended collar; a second mounting through-hole 511 is formed on a sidewall of the steel ball collar 51 corresponding to the first mounting through-hole 213; a second positioning groove 231 is formed at a lower end of the pilot drill bit 23; after the steel ball collar 51 is clamped onto the mounting groove 212 of the quick connecting head 21, the mounting steel ball 52 sequentially passes through the second mounting through-hole 511 and the first mounting through-hole 213 and is then mounted in the second positioning groove 231. It should be noted that when the pilot drill bit 23 needs to be mounted on the quick connecting head 21, the pilot drill bit 23 is first inserted into the quick connecting head 21, the steel ball collar 51 is then clamped onto the mounting groove 212, next, place the mounting steel ball 52 into the second mounting through-hole 511, such that the mounting steel ball 52 sequentially passes through the second mounting through-hole 511 and the first mounting through-hole 213, and so as least part of the mounting steel ball 52 is positioned within the quick connecting head 21, specifically in the second positioning groove 231 of the pilot drill bit 23 inserted into the quick connecting head 21, thereby achieving the mounting of the pilot drill bit 23. Quick locking and unlocking of the pilot drill bit 23 are controlled through the steel ball collar 51 and the mounting steel ball 52, which is more convenient and efficient than locking the pilot drill bit 23 with a set screw in conventional technology.

Specifically, in this embodiment, the reset assembly 4 comprises positioning pin shafts 41 and reset springs 42; the positioning pin shafts 41 sequentially pass through the drill bit limiting sleeve 11 and the upper cover 123; knurled patterns at a lower end of each of the positioning pin shafts 41 is riveted with the sliding sleeve 122; each of the reset springs 42 sleeves a corresponding one of the positioning pin shafts 41; when the sliding sleeve is pulled downward along the axial direction of the drill bit limiting sleeve 11, the reset springs 42 are in a compressed state.

Specifically, in this embodiment, the upper cover 123 is fixedly connected to the drill bit limiting sleeve 11 through screws 7.

Specifically, in this embodiment, the steel ball collar 51 is provided with a locking protrusion 512; a U-shaped groove 214 is formed on the quick connecting head 21 or the drill bit limiting sleeve 11; the locking protrusion 512 is inserted into the U-shaped groove 214 to achieve a locking effect. It should be noted that, the locking protrusion 512 is inserted into the U-shaped groove 214 such that the steel ball collar 51 is prevented from rotation and displacement which may otherwise affect the precision and efficiency of hole-opening, so that the pilot drill bit 23 can be firmly mounted on the quick connecting head 21 or the drill bit limiting sleeve 11; the pilot drill bit 23 provides positioning and guiding functions when the cylindrical hole saw 22 performs hole-opening so that precision in hole-opening can be improved.

Specifically, in this embodiment, the ejection mechanism 3 comprises an ejection block 31, an ejection spring 32, and a spring fixing ring 33; the ejection spring 32 is mounted in the first accommodating cavity 111 through the spring fixing ring 33; one end of the ejection block 31 abuts against the ejection spring 32, and another end of the ejection block 31 abuts against the quick connecting head 21. It should be noted that when the sliding sleeve 122 is pulled downward along the axial direction of the drill bit limiting sleeve 11, the unlocked state of the quick connecting head 21 is achieved; in this case, the ejection block 31 ejects the quick connecting head 21 upwardly (away from the sliding sleeve 122) along the axial direction of the drill bit limiting sleeve 11, thereby facilitating removal of the hole-opening assembly 2.

Specifically, in this embodiment, two positioning planes 1111 are symmetrically provided on a circumferential sidewall of an opening of the first accommodating cavity 111, thereby facilitating positioning and mounting of the quick connecting head 21.

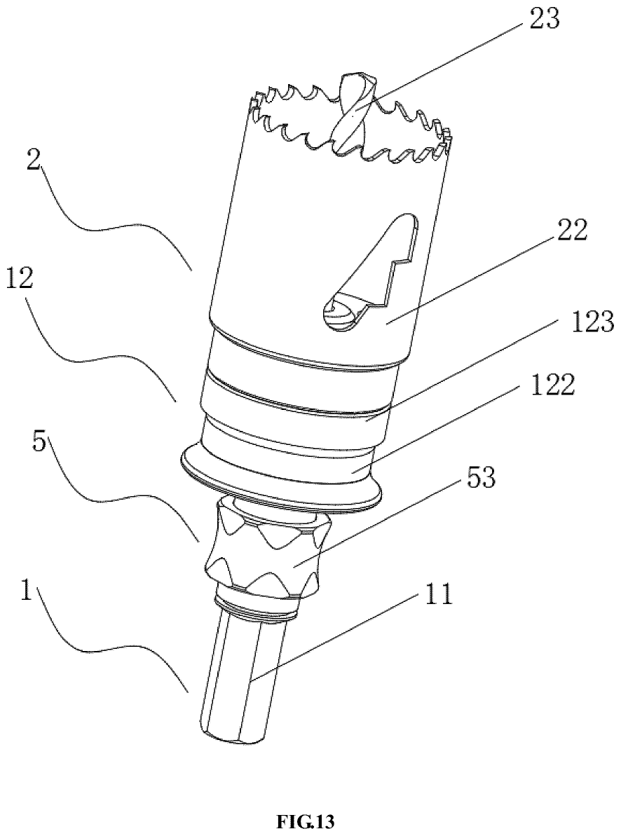

Specifically, in this embodiment, scrap discharge grooves 221 are formed on a circumferential sidewall of the cylindrical hole saw 22 to facilitate the discharge of scraps to improve the hole-opening precision and the working efficiency.
Embodiment 2: As shown in FIGS. 13 to 22, on the basis and according to the teachings of embodiment 2, the collar assembly 5 is provided on the drill bit limiting sleeve 11 in this embodiment:

Specifically, in this embodiment, the pilot drill bit 23 is mounted on the drill bit limiting sleeve 11 through the collar assembly 5; the collar assembly 5 comprises a steel ball collar 51, a mounting steel ball 52, and a steel ball collar fixing sleeve 53; a mounting groove 212 is formed at a lower end of the drill bit limiting sleeve 11; a first mounting through-hole 213 is formed on a bottom wall of the mounting groove 212; the steel ball collar 51 is an open-ended collar as in embodiment 1; a second mounting through-hole 511 (referenced in FIGS. 1-12) is formed on a sidewall of the steel ball collar 51 corresponding to the first mounting through-hole 213 as in embodiment 1; a second positioning groove 231 is formed at a lower end of the pilot drill bit 23; after the steel ball collar 51 is clamped onto the mounting groove 212 of the drill bit limiting sleeve 11, the mounting steel ball 52 sequentially passes through the second mounting through-hole 511 and the first mounting through-hole 213, and at least part of the mounting steel ball 52 is mounted in the second positioning groove 231 of the pilot drill bit 23; a first limiting part 531 and a second limiting part 532 are provided on an inner sidewall of the steel ball collar fixing sleeve 53; an inner diameter of the first limiting part 531 is smaller than an inner diameter of the second limiting part 532; the steel ball collar fixing sleeve 53 is movably sleeved on the drill bit limiting sleeve 11 movable along the axial direction of the drill bit limiting sleeve 11; by moving the steel ball collar fixing sleeve 53 axially along the drill bit limiting sleeve 11, the first limiting part 531 and the second limiting part 532 are selectively positioned corresponding to the mounting steel ball 52 to achieve a locked state and an unlocked state of the pilot drill bit 23 respectively, thereby locking and unlocking the pilot drill bit 23 with respective to the drill bit limiting sleeve 11. It should be noted that, when the pilot drill bit 23 needs to be mounted on the drill bit limiting sleeve 11, the pilot drill bit 23 will first need to pass through the quick connecting head 21 to reach the drill bit limiting sleeve 11, the steel ball collar 51 is then clamped onto the mounting groove 212 of the drill bit limiting sleeve 11, the mounting steel ball 52 is inserted into the second mounting through-hole 511 such that the mounting steel ball 52 sequentially passes through the second mounting through-hole 511 and the first mounting through-hole 213, and then at least part of the mounting steel ball 52 enters into the drill bit limiting sleeve 11; in this case, the mounting steel ball 52 is mounted in the second positioning groove 231 of the drill bit limiting sleeve 11. When the steel ball collar fixing sleeve 53 is pulled downward (away from the cylindrical hole saw 22), the first limiting part 531 abuts against the mounting steel ball 52 and pushing the mounting steel ball 52 into the second positioning groove 231 of the pilot drill bit 23, thereby achieving locking of the pilot drill bit 23; when the steel ball collar fixing sleeve 53 is pushed upward (towards from the cylindrical hole saw 22), the first limiting part 531 is driven to move upward and positioned above the mounting steel ball 52, and so the mounting steel ball 52 is now positioned corresponding to the second limiting part 532 which has a larger diameter than that of the first limiting part 531, and so the mounting steel ball 52 is allowed to move out of the second positioning groove 231 of the pilot drill bit 23 due to the larger space provided by the larger diameter of the second limiting part 532, thereby achieving the unlocking state of the pilot drill bit 23. In the present invention, the quick locking and unlocking of the pilot drill bit 23 are controlled through the steel ball collar fixing sleeve 53, the steel ball collar 51, and the mounting steel ball 52, which is more convenient and efficient than locking the pilot drill bit 23 with a set screw according to conventional technology.

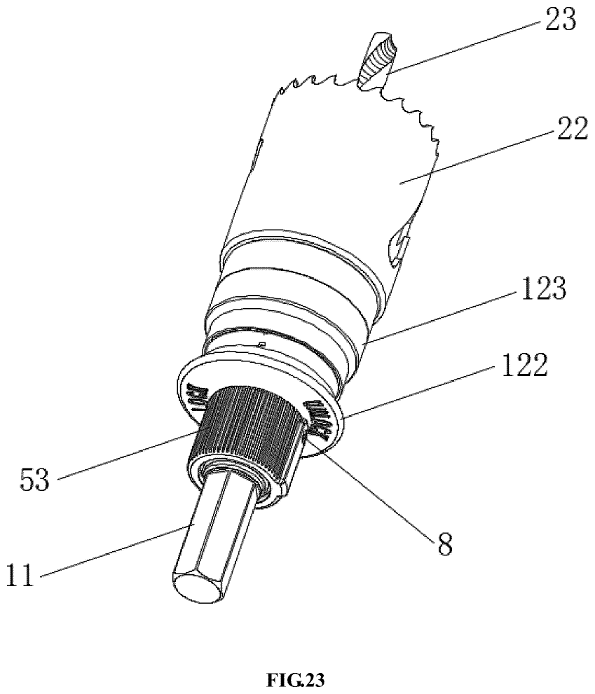

Specifically, in this embodiment, the collar assembly 5 further comprises a first snap ring 54 and a second snap ring 55; the drill bit limiting sleeve 11 is provided with a first ring groove 113 and a second ring groove 114; the first snap ring 54 is fitted in the first ring groove 113; the second snap ring 55 is fitted in the second ring groove 114; a limiting ring 533 is provided inside an upper end of the steel ball collar fixing sleeve 53; the limiting ring 533 is driven to move along the axial direction of the drill bit limiting sleeve 11 as the steel ball collar fixing sleeve 53 moves along the axial direction of the drill bit limiting sleeve 11, such that the limiting ring 533 engages selectively with the first snap ring 54 or the second snap ring 55 as the steel ball collar fixing sleeve 53 moves to different positions. It should be noted that, when the steel ball collar fixing sleeve 53 is pulled downward along the axial direction of the drill bit limiting sleeve 11, the limiting ring 533 engages with and being limited by the second snap ring 55 when the steel ball collar fixing sleeve 53 is pulled downward; when the steel ball collar fixing sleeve 53 is pushed upward along the axial direction of the drill bit limiting sleeve 11, the limiting ring 533 engages with and being limited by the first snap ring 54 when the steel ball collar fixing sleeve 53 is pushed upward.
Embodiment 3: as shown in FIGS. 23 to 29, the structures of the collar assembly 5 and the drill bit limiting sleeve 11 are modified based on Embodiment 2.

Specifically, in this embodiment, the pilot drill bit 23 is mounted on the drill bit limiting sleeve 11 through the collar assembly 5; the collar assembly 5 comprises a steel ball collar 51, a mounting steel ball 52, and a steel ball collar fixing sleeve 53; a mounting groove 212 (referenced in FIGS. 1-12) is formed at a lower end of the drill bit limiting sleeve 11; a first mounting through-hole 213 (referenced in FIGS. 1-12) is formed on a bottom wall of the mounting groove 212; the steel ball collar 51 is an open-ended collar; a second mounting through-hole 511 (referenced in FIGS. 1-12) is formed on a sidewall of the steel ball collar 51 corresponding to the first mounting through-hole 213; a second positioning groove 231 is formed at a lower end of the pilot drill bit 23; after the steel ball collar 51 is clamped onto the mounting groove 212 of the drill bit limiting sleeve 11, the mounting steel ball 52 sequentially passes through the second mounting through-hole 511 and the first mounting through-hole 213, and at least part of the mounting steel ball 52 is mounted in the second positioning groove 231 of the pilot drill bit 23; a locking protruding part 534 and an unlocking indenting part 535 are oppositely provided on an inner sidewall of the steel ball collar fixing sleeve 53; the steel ball collar fixing sleeve 53 rotatably sleeves the drill bit limiting sleeve 11; the steel ball collar fixing sleeve 53 is rotatable about the drill bit limiting sleeve 11, such that when the steel ball collar fixing sleeve 53 is rotated, the mounting steel ball 52 is abutted by the locking protruding part 534 when the steel ball collar fixing sleeve 53 is rotated to a position where the locking protruding part 534 is facing to the mounting steel ball 52, and the mounting steel ball 52 is allowed to move out from the second positioning groove 231 of the pilot drill bit 23 towards a recessed space created by the unlocking indenting part 535 when the steel ball collar fixing sleeve 53 is rotated to a position where the unlocking indenting part 535 is facing to the mounting steel ball 52, thereby forming a locked state and an unlocked state of the pilot drill bit 23 with respect to the drill bit limiting sleeve 11. It should be noted that, the present invention has the functions of accurate positioning and reliable locking: by using the steel ball collar 51, the mounting steel ball 52, and the steel ball collar fixing sleeve 53 having the locking protruding part 534 and the unlocking indenting part 535, stable and accurate locking and unlocking of the pilot drill bit 23 with respect to the drill bit limiting sleeve 11 are realized. In the locked state, the locking protruding part 534 abuts against the mounting steel ball 52, such that the pilot drill bit 23 is effectively prevented from displacement or loosening during operation, thereby ensuring the precision and stability of the hole-opening operation and meeting the high machining precision requirements in demanding operation scenarios.

Specifically, in this embodiment, the mounting steel ball 52 has a capsule shape having a cylindrical body and two spherical ends.

Specifically, in this embodiment, a projected portion 536 and anti-skidding stripes 537 are provided on an outer sidewall of the steel ball collar fixing sleeve 53; a positioning through-hole 538 for mounting a rotation positioning member 8 is formed at an upper end of the projected portion 536. It should be noted that, the present invention is convenient to operate in that the projected portion 536 on the outer sidewall of the steel ball collar fixing sleeve 53 facilitate a user to rotate the steel ball collar fixing sleeve 53 through the projected portion 536, and to be easily informed of whether the pilot drill bit 23 is in a locked state or an unlocked state (see FIG. 23), wherein the locked and unlocked states of the pilot drill bit 23 are switched by rotating the steel ball collar fixing sleeve 53 through the projected portion 536, accordingly, operation is simple and intuitive, and the mounting, disassembly, and replacement of the pilot drill bit 23 can be completed quickly without complex tools or cumbersome steps, thereby improving working efficiency and reducing equipment downtime. The anti-skidding stripes 537 provided on the outer sidewall of the steel ball collar fixing sleeve 53 increase the friction between the hand of the user and the steel ball collar fixing sleeve 53 to provide tactile support, such that the hand of the user can apply force and control the projected portion 536 better during operation. Even if the hand has sweat or even in a relatively humid working environment, the accuracy and stability of operation can also be ensured, and so the operation experience of the user is improved.

Specifically, in this embodiment, the rotation positioning member 8 comprises a positioning pin 81, a positioning steel ball 82, and a positioning spring 83; the positioning pin 81 is mounted in the positioning through-hole 538; one end of the positioning spring 83 abuts against one end of the positioning pin 81, and another end of the positioning spring 83 abuts against the positioning steel ball 82; the positioning steel ball 82 is provided at an opening of another end of the positioning pin 81; a positioning recess 115 is formed on an outer sidewall of the drill bit limiting sleeve 11 aligning to the first mounting through-hole 213; when the steel ball collar fixing sleeve 53 is rotated through the projected portion 536, the positioning steel ball 82 enters into the positioning recess 115 when the steel ball collar fixing sleeve 53 is rotated to a position where the positioning steel ball 82 is positioned facing to the positioning recess 115, and the positioning steel ball 82 leaves the positioning recess 115 when the steel ball collar fixing sleeve 53 is rotated to any position where the positioning steel ball 82 is not facing to the positioning recess 115. It should be noted that, the present invention has the function of preventing misoperation: The rotation positioning member 8 (the positioning pin 81, the positioning steel ball 82, and the positioning spring 83) is in functional cooperation with the positioning recess 115 formed on the outer sidewall of the drill bit limiting sleeve 11. When the steel ball collar fixing sleeve 53 is rotated through the projected portion 536 towards a same direction, the positioning steel ball 82 will alternately enter and leave the positioning recess 115 for every rotation of 180 degrees of the steel ball collar fixing sleeve 53; such a design can effectively prevent accidental rotation of the steel ball collar fixing sleeve 53, thereby avoiding the locked state of the pilot drill bit 23 from being ineffective due to misoperation of the steel ball collar fixing sleeve 53 during hole-opening operation, and this further enhances the use safety and reliability of the present invention. It should be noted that, the positioning spring 83 in the rotation positioning member 8 plays a key role in the function of positioning. When the steel ball collar fixing sleeve 53 is rotated through the projected portion 536, the positioning spring 83 applies an elastic force on the positioning steel ball 82. In an initial state where the steel ball collar fixing sleeve 53 is rotated about the drill bit limiting sleeve 11 where the positioning steel ball 82 is not facing to the positioning recess 115, the positioning steel ball 82 is always maintained at the opening of the positioning pin 81 abutting against the outer sidewall of the drill bit limiting sleeve 11 under the elastic force of the positioning spring 83. When the steel ball collar fixing sleeve 53 is rotated through the projected portion 536 to a certain angle (for example, rotated by 180 degrees), the positioning steel ball 82 can accurately enter the positioning recess 115 on the outer sidewall of the drill bit limiting sleeve 11 under the thrust by the elastic force of the positioning spring 83, and so the steel ball collar fixing sleeve 53 is fixed in position. This positioning method can ensure that the steel ball collar fixing sleeve 53 can remain stable in both the locked and unlocked states of the pilot drill bit 23, preventing the steel ball collar fixing sleeve 53 from changing the state of the pilot drill bit 23 due to accidental rotation, and effectively ensuring the reliability of the locked and unlocked state of the pilot drill bit 23 with respect to the drill bit limiting sleeve 11.

In summary, the present invention has the following beneficial effects:

Convenient replacement of the hole-opening assembly: Through the cooperation between the sliding sleeve 122 and the limiting steel ball 121 in the limiting mechanism 12 and the quick connecting head 21, quick locking and unlocking of the drill bit limiting sleeve 11 with respect to the quick connecting head 21 are achieved. When the sliding sleeve 122 is pulled downward to achieve the unlocked state of the quick connecting head 21, the ejection mechanism 3 can eject the quick connecting head 21, such that the hole-opening assembly 2 (consisting of the quick connecting head 21, the pilot drill bit 23, and the cylindrical hole saw 22) can be conveniently and quickly replaced without laborious screwing as required by conventional threaded connection, thereby avoiding the problem of difficulty in disassembly due to thread stripping or seizing, and greatly improving the replacement efficiency.

Flexible mounting of the pilot drill bit 23: The present invention provides multiple mounting methods for the pilot drill bit 23. The pilot drill bit 23 can be mounted on the quick connecting head 21 or the drill bit limiting sleeve 11 through the collar assembly 5. Moreover, there are also various ways to mount the collar assembly 5 onto the drill bit limiting sleeve 11, for example, the locking and unlocking of the pilot drill bit 23 are achieved through the rotation of the steel ball collar fixing sleeve 53. Accordingly, different use demands and working conditions can be met, thereby increasing the applicability and flexibility of the present invention.

Effective removal of wastes: Since the hole-opening assembly 2 can be conveniently disassembled, the wastes inside the cylindrical hole saw 22 can be easily cleaned, thereby avoiding the adverse effects of the residual wastes on the precision and quality of the hole-opening operation and the performance and service life of the cylindrical hole saw 22, and ensuring the good operation state and long-term stable operation of the cylindrical hole saw 22.

Ingenious and reliable structural design: The reset assembly 4 can ensure that the sliding sleeve 122 can be accurately reset after operation, thereby ensuring the stability of the locked state of the quick connecting head 21; the ejection mechanism 3 can powerfully eject the quick connecting head 21; the components are tightly matched with each other and work cooperatively, and the overall structural design is ingenious and reasonable, such that the reliability and practicability of the hole saw connecting mechanism are improved, the maintenance cost and the use difficulty are reduced, and the user's experience and the working efficiency are improved.

The technical solutions provided in the embodiments of the present invention are described in detail above, and specific examples are applied herein to explain the principles and implementations of the embodiments of the present invention. The description of the embodiments above is only used to help understand the principles of the embodiments of the present invention. For those of ordinary skill in the art, on the basis of the embodiments of the present invention, the specific ways and ranges of applications may change. In summary, the contents of this specification should not be construed as a limitation to the present invention.

What is claimed is:

1. A hole saw connecting mechanism, comprising a rotary shaft assembly and a hole-opening assembly; an upper end of the rotary shaft assembly is detachably connected to the hole-opening assembly, and a lower end of the rotary shaft assembly is configured to be connected to a driving assembly that drives the hole-opening assembly to rotate; wherein the rotary shaft assembly comprises a drill bit limiting sleeve and a limiting mechanism; the hole-opening assembly comprises a quick connecting head, a pilot drill bit, and a cylindrical hole saw; the limiting mechanism comprises a limiting steel ball, a sliding sleeve, and an upper cover; an upper end of the drill bit limiting sleeve is provided with a first accommodating cavity in which a lower end of the quick connecting head is mounted; an ejection mechanism is also provided in the first accommodating cavity; threads at an upper end of the quick connecting head are connected to the cylindrical hole saw; an inner circular sidewall of the sliding sleeve is divided into an upper inner circular sidewall and a lower inner circular sidewall; a diameter of the upper inner circular sidewall is larger than a diameter of the lower inner circular sidewall; a first limiting hole is provided penetrating through opposite sidewalls of the drill bit limiting sleeve at the upper end of the drill bit limiting sleeve corresponding to the first accommodating cavity, and the limiting steel ball is mounted in the first limiting hole; the quick connecting head is provided with a first positioning groove, and the limiting steel ball is limited within the first positioning groove; the upper cover is fixedly connected with the drill bit limiting sleeve; when the sliding sleeve is pulled downward away from the cylindrical hole saw along an axial direction of the drill bit limiting sleeve, the lower inner circular sidewall is driven to move below the limiting steel ball such that the upper inner circular sidewall is positioned corresponding to the limiting steel ball and thus no longer limits the limiting steel ball due to a larger diameter thereof compared with that of the lower inner circular sidewall, and so the limiting steel ball is allowed to move out from the first positioning groove and thus achieve an unlocked state of the quick connecting head, and the quick connecting head is allowed to be ejected by the ejection mechanism; when the sliding sleeve is reset to an original normal position through a reset assembly, the lower inner circular sidewall is driven upward such that the limiting steel ball is again abutted by the lower inner circular sidewall of the sliding sleeve, and so the limiting steel ball is being pushed back into the first positioning groove and thus achieve a locked state of the quick connecting head; the limiting steel ball moving in and out of the first positioning groove due to movements of the sliding sleeve along the axial direction of the drill bit limiting sleeve achieves said locked state and said unlocked state of the quick connecting head, such that the quick connecting head is capable to be locked or unlocked with respect to the drill bit limiting sleeve; the pilot drill bit is mounted on the quick connecting head or on the drill bit limiting sleeve through a collar assembly.

2. The hole saw connecting mechanism of claim 1, wherein the pilot drill bit is mounted on the quick connecting head through the collar assembly; the collar assembly comprises a steel ball collar and a mounting steel ball; a mounting groove is formed at a lower end of the quick connecting head; a first mounting through-hole is formed on a bottom wall of the mounting groove; the steel ball collar is an open-ended collar; a second mounting through-hole is formed on a sidewall of the steel ball collar corresponding to the first mounting through-hole; a second positioning groove is formed at a lower end of the pilot drill bit; after the steel ball collar is clamped onto the mounting groove of the quick connecting head, the mounting steel ball sequentially passes through the second mounting through-hole and the first mounting through-hole and is then mounted in the second positioning groove.

3. The hole saw connecting mechanism of claim 1, wherein the pilot drill bit is mounted on the drill bit limiting sleeve through the collar assembly; the collar assembly comprises a steel ball collar, a mounting steel ball, and a steel ball collar fixing sleeve; a mounting groove is formed at a lower end of the drill bit limiting sleeve; a first mounting through-hole is formed on a bottom wall of the mounting groove; the steel ball collar is an open-ended collar; a second mounting through-hole is formed on a sidewall of the steel ball collar corresponding to the first mounting through-hole; a second positioning groove is formed at a lower end of the pilot drill bit; after the steel ball collar is clamped onto the mounting groove of the drill bit limiting sleeve, the mounting steel ball sequentially passes through the second mounting through-hole and the first mounting through-hole, and at least part of the mounting steel ball is mounted in the second positioning groove of the pilot drill bit; a first limiting part and a second limiting part are provided on an inner sidewall of the steel ball collar fixing sleeve; an inner diameter of the first limiting part is smaller than an inner diameter of the second limiting part; the steel ball collar fixing sleeve is movably sleeved on the drill bit limiting sleeve movable along the axial direction of the drill bit limiting sleeve; by moving the steel ball collar fixing sleeve axially along the drill bit limiting sleeve, the first limiting part and the second limiting part are selectively positioned corresponding to the mounting steel ball to achieve a locked state and an unlocked state of the pilot drill bit respectively, thereby locking and unlocking the pilot drill bit with respective to the drill bit limiting sleeve.

4. The hole saw connecting mechanism of claim 1, wherein the pilot drill bit is mounted on the drill bit limiting sleeve through the collar assembly; the collar assembly comprises a steel ball collar, a mounting steel ball, and a steel ball collar fixing sleeve; a mounting groove is formed at a lower end of the drill bit limiting sleeve; a first mounting through-hole is formed on a bottom wall of the mounting groove; the steel ball collar is an open-ended collar; a second mounting through-hole is formed on a sidewall of the steel ball collar corresponding to the first mounting through-hole; a second positioning groove is formed at a lower end of the pilot drill bit; after the steel ball collar is clamped onto the mounting groove of the drill bit limiting sleeve, the mounting steel ball sequentially passes through the second mounting through-hole and the first mounting through-hole, and at least part of the mounting steel ball is mounted in the second positioning groove of the pilot drill bit; a locking protruding part and an unlocking indenting part are oppositely provided on an inner sidewall of the steel ball collar fixing sleeve; the steel ball collar fixing sleeve rotatably sleeves the drill bit limiting sleeve; the steel ball collar fixing sleeve is rotatable about the drill bit limiting sleeve, such that when the steel ball collar fixing sleeve is rotated, the mounting steel ball is abutted by the locking protruding part when the steel ball collar fixing sleeve is rotated to a position where the locking protruding part is facing to the mounting steel ball, and the mounting steel ball is allowed to move out from the second positioning groove of the pilot drill bit towards a recessed space created by the unlocking indenting part when the steel ball collar fixing sleeve is rotated to a position where the unlocking indenting part is facing to the mounting steel ball, thereby forming a locked state and an unlocked state of the pilot drill bit with respect to the drill bit limiting sleeve.

5. The hole saw connecting mechanism of claim 3, wherein the collar assembly further comprises a first snap ring and a second snap ring; the drill bit limiting sleeve is provided with a first ring groove and a second ring groove; the first snap ring is fitted in the first ring groove; the second snap ring is fitted in the second ring groove; a limiting ring is provided inside an upper end of the steel ball collar fixing sleeve; the limiting ring is driven to move along the axial direction of the drill bit limiting sleeve as the steel ball collar fixing sleeve moves along the axial direction of the drill bit limiting sleeve, such that the limiting ring engages selectively with the first snap ring or the second snap ring as the steel ball collar fixing sleeve moves to different positions.

6. The hole saw connecting mechanism of claim 4, wherein a projected portion and anti-skidding stripes are provided on an outer sidewall of the steel ball collar fixing sleeve; a positioning through-hole in which a rotation positioning member is mounted is formed at an upper end of the projected portion.

7. The hole saw connecting mechanism of claim 6, wherein the rotation positioning member comprises a positioning pin, a positioning steel ball, and a positioning spring; the positioning pin is mounted in the positioning through-hole; one end of the positioning spring abuts against one end of the positioning pin, and another end of the positioning spring abuts against the positioning steel ball; the positioning steel ball is provided at an opening of another end of the positioning pin; a positioning recess is formed on an outer sidewall of the drill bit limiting sleeve aligning to the first mounting through-hole; when the steel ball collar fixing sleeve is rotated through the projected portion, the positioning steel ball enters into the positioning recess when the steel ball collar fixing sleeve is rotated to a position where the positioning steel ball is positioned facing to the positioning recess, and the positioning steel ball leaves the positioning recess when the steel ball collar fixing sleeve is rotated to any position where the positioning steel ball is not facing to the positioning recess

8. The hole saw connecting mechanism of claim 2, wherein the steel ball collar is provided with a locking protrusion; a U-shaped groove is formed on the quick connecting head; the locking protrusion is inserted into the U-shaped groove.

9. The hole saw connecting mechanism of claim 3, wherein the steel ball collar is provided with a locking protrusion; a U-shaped groove is formed on the drill bit limiting sleeve; the locking protrusion is inserted into the U-shaped groove.

10. The hole saw connecting mechanism of claim 1, wherein the reset assembly comprises positioning pin shafts and reset springs; the positioning pin shafts sequentially pass through the drill bit limiting sleeve and the upper cover; knurled patterns at a lower end of each of the positioning pin shafts is riveted with the sliding sleeve; each of the reset springs sleeves a corresponding one of the positioning pin shafts; when the sliding sleeve is pulled downward along the axial direction of the drill bit limiting sleeve, the reset springs are in a compressed state.

11. The hole saw connecting mechanism of claim 1, wherein the ejection mechanism comprises an ejection block, an ejection spring, and a spring fixing ring; the ejection spring is mounted in the first accommodating cavity through the spring fixing ring; one end of the ejection block abuts against the ejection spring, and another end of the ejection block abuts against the quick connecting head.
